(19) United States
(12) Patent Application Publication
(10) Pub. No.: US 2003/0142132 A1
(43) Pub. Date: Jul. 31, 2003

(54) Selectively adjusting the translucency of windows in response to a scroll wheel rotation

(75) Inventors: Michael Wayne Brown, Georgetown, TX (US); Andrew Douglas Hately, Austin, TX (US); Kelvin Roderick Lawrence, Round Rock, TX (US); Michael A. Paolini, Austin, TX (US)

Correspondence Address: Marilyn Smith Dawkins, International Business Machines Corporation, Intl Prop Law Dept., Internal Zip 4054, 11400 Burnet Road, Austin, TX, 78758, US

(73) Assignee: International Business Machines Corporation, Armonk, NY

(21) Appl. No.: 10/058,493

(22) Filed: Jan. 28, 2002

(51) Int. Cl. G09G 5/00

(52) U.S. Cl. 345/768

(57) ABSTRACT

A method, system, and program for selectively adjusting windows in response to a scroll wheel rotation are provided. A rotation of a scroll wheel position is detected. Then the transparency of at least one displayable object located at a particular z-order level within a graphical interface is adjusted according to the rotation of the scroll wheel position.

### CROSS-REFERENCE TO RELATED APPLICATIONS

The present application is related to the following co-pending applications, which are filed on even date herewith and incorporated herein by reference:

(1) U.S. patent application Ser. No. ______ (Attorney Docket No. AUS920010513US1); and

(2) U.S. patent application Ser. No. ______ (Attorney Docket No. AUS920010514US1);

(3) U.S. patent application Ser. No. ______ (Attorney Docket No. AUS920010515US1);

(4) U.S. patent application Ser. No. ______ (Attorney Docket No. AUS920010516US1);

(5) U.S. patent application Ser. No. ______ (Attorney Docket No. AUS920010517US1);

(6) U.S. patent application Ser. No. ______ (Attorney Docket No. AUS920010518US1);

(7) U.S. patent application Ser. No. ______ (Attorney Docket No. AUS920010519US1);

(8) U.S. patent application Ser. No. ______ (Attorney Docket No. AUS920010520US1);

(9) U.S. patent application Ser. No. ______ (Attorney Docket No. AUS920010521US1);

(10) U.S. patent application Ser. No. ______ (Attorney Docket No. AUS920010522US1);

(11) U.S. patent application Ser. No. ______ (Attorney Docket No. AUS920010525US1).

### BACKGROUND OF THE INVENTION

1. Technical Field

The present invention relates in general to computer systems and, in particular, to graphical user interfaces. Still more particularly, the present invention relates to adjusting displayable objects within a graphical user interface in response to the rotation of a scroll wheel.

2. Description of the Related Art

Most operating systems provide a graphical user interface (GUI) for controlling a visual computer environment that represents programs, files, and options with graphical images, such as icons, menus, and dialog boxes on the screen. Graphical items defined within the GUI work the same way for the user in most software because the GUI provides standard software routines to handle these elements and report the user's actions.

A typical graphical object defined by a GUI is a window or other defined area of a display that contains distinguishable text, graphics, video, audio and other information for output. A display area may contain multiple windows that are associated with a single software program or multiple software programs executing concurrently.

Often when multiple graphical objects are displayed concurrently, the graphical objects will overlap. The order in which graphical objects are drawn on top of one another onscreen to simulate depth is typically known as the z-order. Typically, those objects at the top of the z-axis obscure the view of those graphical objects drawn below.

In some operating systems, a level of transparency or translucency may be applied to graphical objects, and in particular to windows. By applying a level of translucency to upper level windows, lower level windows are visible therethrough. Utilizing translucency is particularly advantageous such that the title bars for multiple levels of windows are visible where the windows overlap.

According to U.S. Pat. No. 5,651,107, the transparency of each window may be individually adjusted by selectively adjusting a transparency scroll bar in each window. However, one limitation of such a scroll bar is that additional screen space is required for each window to adjust transparency. In addition, another limitation of such a transparency scroll bar is that other graphical objects, such as icons, do not include the scroll bar, and therefore other methods of adjusting transparency are needed.

Some mouses and other pointing devices include scroll wheels. In response to a rotation of the scroll wheel, the scroll bar of the active window adjusts in position. However, a limitation of scroll wheels is that the rotation of the scroll wheel adjusts a position of a scroll bar within a window to only adjust the position of information within the window.

Therefore, in view of the foregoing, it would be advantageous to provide a method, system, and program for adjusting a transparency of a graphical object, including a window, in response to the rotation of a scroll wheel on a pointing device.

### SUMMARY OF THE INVENTION

In view of the foregoing, it is therefore an object of the present invention to provide an improved computer system.

It is another object of the present invention to provide an improved graphical user interface.

It is yet another object of the present invention to provide a method, system and program for adjusting displayable objects within a graphical user interface in response to the rotation of a scroll wheel.

According to one aspect of the present invention, a rotation of a scroll wheel position is detected. Then the transparency of at least one displayable object located at a particular z-order level within a graphical interface is adjusted according to the rotation of the scroll wheel position.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts one embodiment of a computer system with which the method, system and program of the present invention may advantageously be utilized;

FIGS. 2a-2c illustrate block diagrams of pointing devices including scroll wheels in accordance with the method, system, and program of the present invention;

FIG. 3 depicts a graphical representation of a user interface in which multiple overlapping windows are displayed in accordance with the method, system, and program of the present invention;

FIG. 4 illustrates a graphical representation of a user interface in which the transparency of the top of the z-order is adjusted in response to the adjustment of a scroll wheel position in accordance with the method, system, and program of the present invention;

FIG. 5 depicts a graphical representation of a user interface in which the z-order of multiple windows is adjusted in response to the adjustment of a scroll wheel position in accordance with the method, system, and program of the present invention;

FIG. 6 illustrates a graphical representation of a user interface in which the transparency of the new top window within the z-order is adjusted in accordance with the method, system, and program of the present invention; and

FIG. 7 depicts a block diagram of a high level logic flowchart of a process and program for responding to a scroll wheel rotation in accordance with the method, system, and program of the present invention.

### DETAILED DESCRIPTION OF THE PREFERRED EMBODIMENT

A method, system, and program for adjusting the transparency of windows in response to rotations of a scroll wheel are provided. In particular, while the present invention is described with primary reference to windows, other displayable objects may also be adjusted in transparency according to the present invention. A “displayable object” may include text, icons, video, graphics, windows, or other logical graphical representations displayable within a display area. Displayable objects may be hidden or visible. Further, displayable objects may be layered in a z-order. Moreover, a displayable object may utilize a portion of a display area or may extend across the entirety of a display area. A displayable object may or may not include definable boundaries.

A z-order is the order along the z-axis in which displayable objects appear. Through a z-buffering technique, a depth is associated with each displayable object such that each object appears to be set at a particular depth in comparison with other displayable objects. There may be n-levels of layers within the z-order, where multiple displayable objects may be positioned within a particular n-level of the z-order.

The z-order may be a result of the order in which a user opens displayable objects onto the display. Alternatively, according to one advantage of the present invention, a user may designate for the z-order to be set according to a particular criteria.

Transparency is a graphical feature that is particularly advantageous to the present invention when displaying multiple displayable objects within a user interface where those displayable objects may overlap. As will be understood by one skilled in the art, by making a displayable object appear transparent on a computer screen, other displayable objects below the displayable objects are visible through the resource aid. Further, the transparency of a displayable object may be adjusted from opaque to totally transparent.

Typically, the transparency attribute is stored with color values in an alpha channel. Then, when calculating the appearance of a given pixel, the graphic processor uses the alpha channel values to determine the pixel's color through a process termed alpha blending. Through alpha blending, the process adds a fraction of the color of the transparent object set by the alpha channel value to the color of the displayable object below. Mixing the colors together gives the appearance that the displayable object below is seen through a layer of the transparent displayable object. In addition to alpha blending, additional shading may be added in order to create shadows and other graphical images that cue the viewer to the position of the transparent displayable object.

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### Hardware Overview

The present invention may be executed in a variety of systems, including a variety of computing systems and electronic devices under a number of different operating systems. In one embodiment of the present invention, the computer system is a portable computing system such as a notebook computer, a palmtop computer, a personal digital assistant, a telephone or other electronic computing system that may also incorporate communications features that provide for telephony, enhanced telephony, messaging and information services. However, the computer system may also be, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

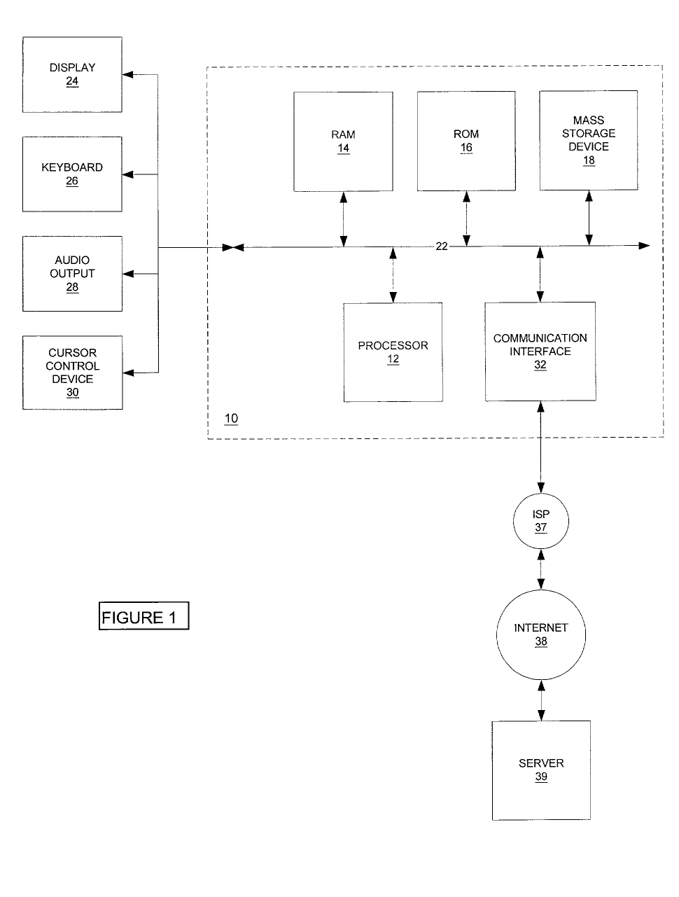

Referring now to the drawings and in particular to FIG. 1, there is depicted one embodiment of a computer system with which the method, system and program of the present invention may advantageously be utilized. Computer system 10 comprises a bus 22 or other communication device for communicating information within computer system 10, and at least one processing device such as processor 12, coupled to bus 22 for processing information. Bus 22 preferably includes low-latency and high-latency paths that are connected by bridges and controlled within computer system 10 by multiple bus controllers.

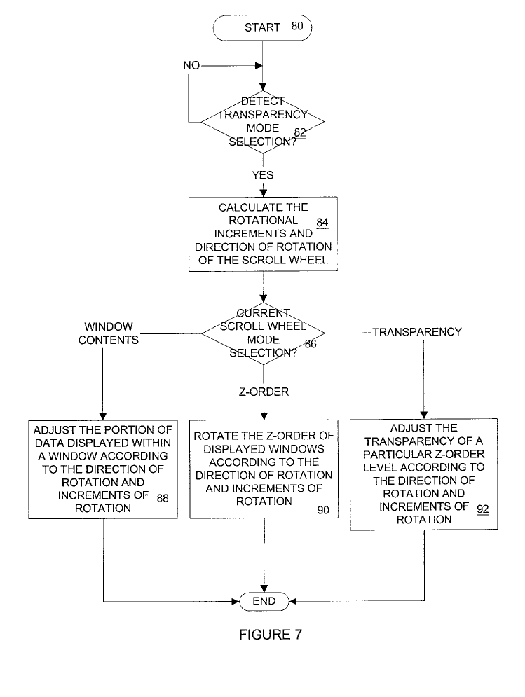

Processor 12 may be a general-purpose processor such as IBM's PowerPC™ processor that, during normal operation, processes data under the control of operating system and application software stored in a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowcharts of FIG. 7 and others described herein. Alternatively, the steps of the present invention might be performed by specific hardware components that contain hardwire logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM), a digital video disc-ROM (DVD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of non-volatile media is storage device 18. Volatile media includes dynamic memory such as RAM 14. Transmission media includes coaxial cables, copper wire or fiber optics, including the wires that comprise bus 22. Transmission media can also take the form of acoustic or light waves, such as those generated during radio wave or infrared data communications.

Moreover, the present invention may be downloaded as a computer program product, wherein the program instructions may be transferred from a remote computer such as a server 39 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital data streams. The signals through the various networks and the signals on network link 34 and through communication interface 32, which carry the digital data to and from computer system 10, are exemplary forms of carrier waves transporting the information.

Further, multiple peripheral components may be added to computer system 10. For example, an audio output 28 is attached to bus 22 for controlling audio output through a speaker or other audio projection device. A display 24 is also attached to bus 22 for providing visual, tactile or other graphical representation formats. A keyboard 26 and cursor control device 30, such as a mouse, trackball, or cursor direction keys, are coupled to bus 22 as interfaces for user inputs to computer system 10. Keyboard 26 and cursor control device 30 can control the position of a cursor positioned within a display area of display 24. Display 24 may include both non-transparent surfaces, such as monitors, and transparent surfaces, such as headset sunglasses or vehicle windshield displays.

It should be understood that keyboard 26 and cursor control device 30 are examples of multiple types of input devices that may be utilized in the present invention. In alternate embodiments of the present invention, additional input and output peripheral components may be added.

### Recently Used Translucency Context

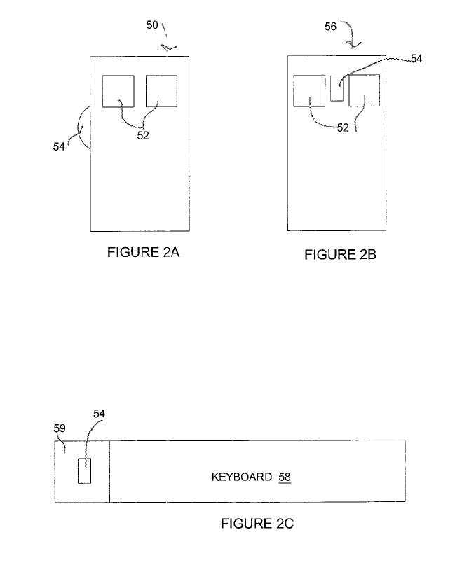

Referring now to FIGS. 2a-2c, there is depicted block diagrams of input devices including scroll wheels in accordance with the method, system, and program of the present invention. As illustrated in FIG. 2a, a pointing device 50 includes touch sensitive buttons 52 that detect the application of pressure. In addition, pointing device 50 includes scroll wheel 54. Scroll wheel may be positioned to either side of point device 50, designed where the thumb is the preferred digit utilized to rotate scroll wheel 54.

As depicted in FIG. 2b, a second pointing device 56 includes touch sensitive buttons 52 and scroll wheel 54. However, scroll wheel 54 is positioned between touch sensitive buttons 52. In particular, scroll wheel 54 may be positioned where the index finger is the preferred digit to be utilized in rotating scroll wheel 54.

As illustrated in FIG. 2c, a keyboard 58 incorporates scroll wheel 54 within a panel 59 offset from keyboard 58. Scroll wheel 54 may be provided within panel 59 or amongst the keys of keyboard 58 as a rotatable device. In addition, other input keys may be provided within panel 59 in association with scroll wheel 54. For example, a switch may be provided within panel 59 that a user may toggle to indicate how input from scroll wheel 54 should be utilized in adjusting a graphical display area.

According to one advantage of the present invention, the rotation of scroll wheel 54 may be detected by a computer system and utilized as input to control the transparency of at least one displayable object displayed within a graphical user interface controlled by the computer system. According to another advantage of the present invention, the rotation of scroll wheel 54 may be detected by a computer system and utilized as input to control the z-order of windows within a graphical user interface controlled by the computer system.

In addition, although scroll wheel 54 is described with reference to a rotatable button, in alternate embodiments, scroll wheel 54 may be a pressure sensitive button, such that increases in pressure upon the pressure sensitive button are translated into an incremental input. In addition, scroll wheel 54 may slide, depress, or be adjustable in an alternate direction, where the adjustment to the location of the button is utilized as an incremental input.

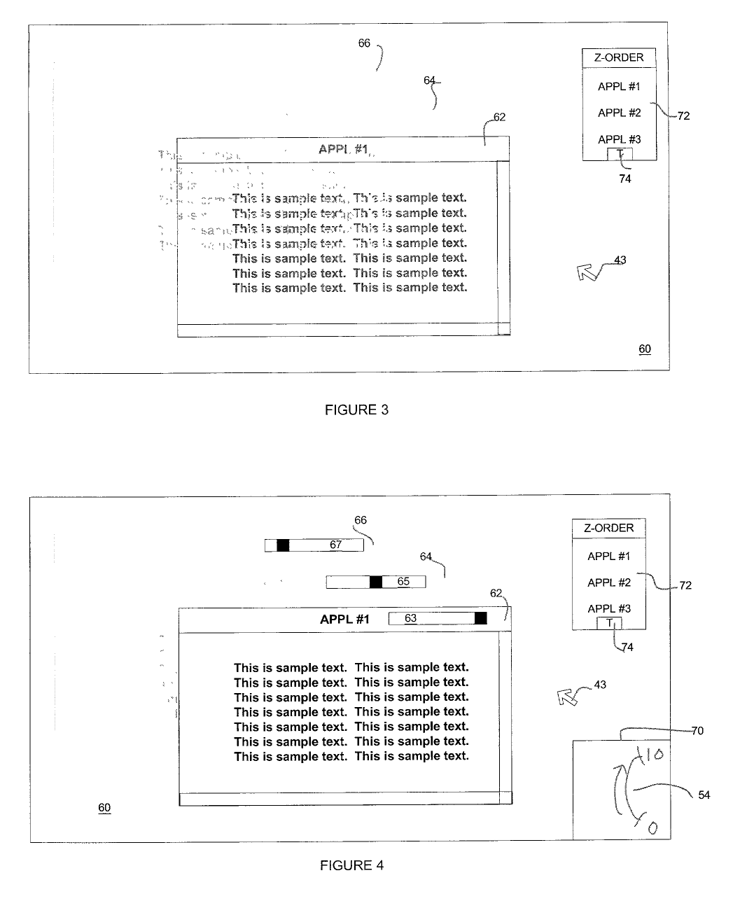

With reference now to FIG. 3, there is illustrated a graphical representation of a user interface in which multiple overlapping windows are displayed in accordance with the method, system, and program of the present invention. As illustrated, a user interface 60 includes windows 62, 64, and 66. In the present example, window 62 is at the top of the z-order followed by window 64 and then window 66. While window 62 is positioned at the top of the z-order, window 62 need not be active.

As depicted, each of windows 62, 64, and 66 are set at a particular level of transparency. In the present example, window 62 is set at 50% transparency, while window 64 is set at 40% transparency and window 66 set at 30% transparency. As is visible within the illustration, where multiple windows are transparent, it becomes increasingly difficult to distinguish between windows.

Further, as illustrated, the z-order of windows 62, 64, and 66 is indicated in z-order block 72 as a graphical aid to enhance the description of the present invention. In addition, z-order block 72 may be displayed in accordance with the present invention as an aid to help a user in viewing the current z-order of windows and other displayable objects within user interface 60.

In particular, a user may provide a particular input to indicate whether rotation of a scroll wheel should be translated into an adjustment in the z-order of windows or translated into an adjustment in the transparency of a window. For example, a user may input a particular key combination, voice input, or pointing device selection, to indicate the function of the scroll wheel. In the present example, a graphical indicator 74 indicates the current status of the scroll wheel, where “Z” indicates adjustments to the z-order and “T” indicates adjustments to transparency.

Referring now to FIG. 4, there is depicted a graphical representation of a user interface in which the transparency of the top of the z-order is adjusted in response to the adjustment of a scroll wheel position in accordance with the method, system, and program of the present invention. As described, window 62 is at the top of the z-order within user interface 60. In the example, window 62 has been adjusted from 50% transparency to 0% transparency, in response to a rotation of a scroll wheel.

A cutout 70 depicts the clockwise rotational adjustment of scroll wheel 54 of pointing device 50. In the example, the rotational adjustment of scroll wheel 54 includes ten increments, where each increment translates to a decrease in transparency of window 52 by 5%. In alternate embodiments of the present invention, multiple windows may be adjusted in transparency concurrently according to the rotational adjustment of scroll wheel 54. In addition, in alternate embodiments of the present invention, the transparency of the top z-order window may increase in response to the rotational adjustment of scroll wheel 54, where scroll wheel 54 is rotated counterclockwise.

According to one advantage of the present invention, in addition to the actual transparency adjustment to window 62, a transparency controller 63 may adjust in order to reflect the current transparency of window 62. In particular, a user may utilize cursor 34 to select transparency controller 63 and adjust the transparency by adjusting the position of a scroll bar within transparency controller 63 or by keying a preferred transparency. In addition, transparency controllers 65 and 67 indicate the current transparency of windows 64 and 66. A user may also select transparency controllers 65 and 67 to adjust the transparency of each of the corresponding windows. As a further advantage, a user may adjust a scroll bar within any of transparency controllers 63, 65, and 67 without selecting a window or adjusting the z-order of the windows.

With reference now to FIG. 5, there is illustrated a graphical representation of a user interface in which the z-order of multiple windows is adjusted in response to the adjustment of a scroll wheel position in accordance with the method, system, and program of the present invention. As depicted, window 62 is pushed backward in the z-order and window 66 is brought forward in the z-order.

A cutout 70 depicts the clockwise rotational adjustment of scroll wheel 54 of pointing device 50. In the example, the rotational adjustment of scroll wheel 54 includes one increment, where each increment translates to a single backward rotation in the z-order level of each window. In alternate embodiments of the present invention, windows may be rotated more than one level within the z-order according to the rotational adjustment of scroll wheel 54. In addition, in alternate embodiments of the present invention, a counterclockwise rotational adjustment of scroll wheel 54 may translate to a forward rotation of windows, such that the window at the top of the z-level is pushed to the back of the z-level.

Further, a user may provide another input (e.g. keyboard input, mouse input, voice input) in coordination with rotation of scroll wheel 54 that isolates rotation of a single window within the z-level order. For example, a user may indicate that only window 52 is to be repositioned in the z-order and that other windows may reposition in the z-order in response to the repositioning of window 52.

According to one advantage of the present invention, the actual z-order of windows may be ordered according to criteria, such as the recent use of windows or resource utilization of a particular resource by applications associated with windows. Therefore, windows may be ordered first according to a particular criteria and then rotated in position within the z-order, while maintaining a position to other windows relative to the original criteria ordering.

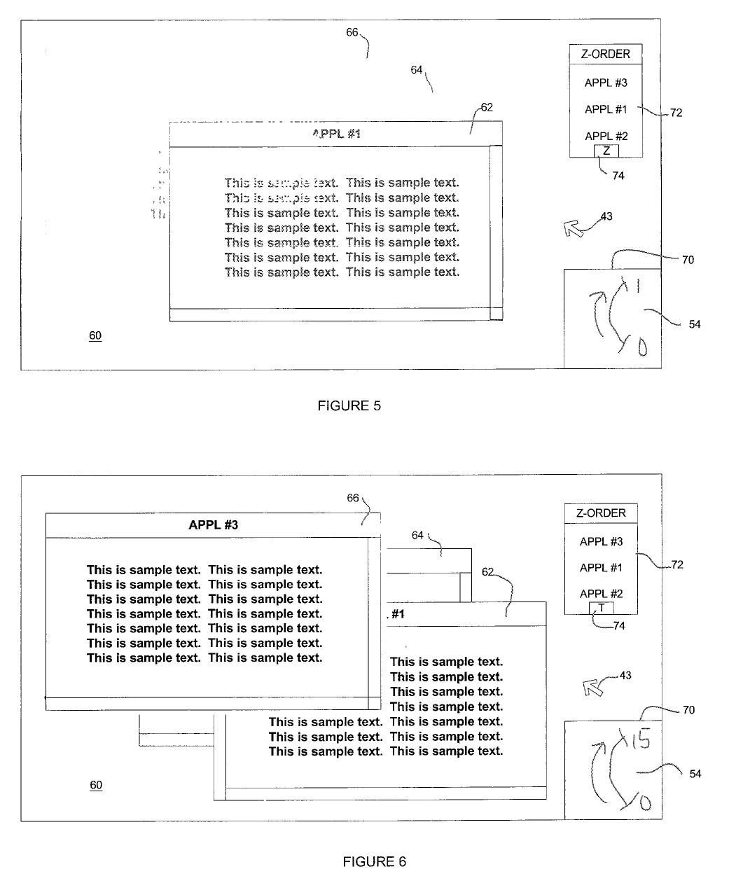

Referring now to FIG. 6, there is depicted a graphical representation of a user interface in which the transparency of the new top window within the z-order is adjusted in accordance with the method, system, and program of the present invention. As illustrated in FIG. 5, window 66 is moved to the top of the z-order, in response to the rotational adjustment of the scroll wheel. In the current example, the scroll wheel has been designated in association with adjusting the transparency of the top windows of the z-order, as indicated by graphical indicator 74.

In the example, the transparency of window 66 is adjusted to 0% transparency in response to the rotational adjustment of scroll wheel 54. Cutout 70 illustrates the rotational adjustment of scroll wheel 54 as the input utilized to determine an adjustment to the transparency of window 66.

According to a further advantage of the present invention, while the top z-order level is adjusted in transparency in the present example, in alternate embodiments, windows and other graphical elements within alternate levels within the z-order may be adjusted in response to a rotational adjustment of scroll wheel 54. In addition, multiple levels within the z-order may be adjusted in transparency simultaneously.

With reference now to FIG. 7, there is illustrated a block diagram of a high level logic flowchart of a process and program for responding to a scroll wheel rotation in accordance with the method, system, and program of the present invention. As illustrated, the process starts at block 80 and thereafter proceeds to block 82.

Block 82 depicts a determination as to whether or not an adjustment to a scroll wheel position is detected. If an adjustment to a scroll wheel position is not detected, then the process iterates at block 82. If an adjustment to a scroll wheel position is detected, then the process passes to block 84. Block 84 illustrates calculating the incremental rotation of the adjustment to the scroll wheel and the direction of the incremental rotation.

Next, block 84 illustrates a determination as to the current scroll wheel mode selection. If the current scroll wheel mode selection is an adjustment to window contents, then the process passes to block 88. Block 88 depicts adjusting the portion of data displayed within a window according to the increments and direction of rotation. Then, the process ends.

At block 84, if the current scroll wheel mode selection is an adjustment to the z-order, then the process passes to block 90. Block 90 illustrates rotating the z-order of the displayed windows according to the increments and direction of rotation. Then, the process ends.

Or, at block 84, if the current scroll wheel mode selection is an adjustment to transparency, then the process passes to block 92. Block 92 depicts adjusting the transparency of the top z-order displayable objects according to the increments and direction of rotation. Then, the process ends.

While the invention has been particularly shown and described with reference to a preferred embodiment, it will be understood by those skilled in the art that various changes in form and detail may be made therein without departing from the spirit and scope of the invention.

What is claimed is:

1. A method for adjusting a transparency of a displayable object within a graphical interface, said method comprising the step of:
detecting a rotation of a scroll wheel position; and
adjusting a transparency of at least one displayable object located at a particular z-order level within a graphical interface according to said rotation of said scroll wheel position, such that said transparency of said at least one displayable object is incrementally adjusted according to said scroll wheel position.

2. The method for adjusting a transparency of a displayable object within a graphical interface according to claim 1, said step of adjusting a transparency further comprising the step of:
adjusting a transparency of at least one window within a top level of said z-order.

3. The method for adjusting a transparency of a displayable object within a graphical interface according to claim 1, said method further comprising the step of:
rotating an order of said at least one displayable object within said z-order.

4. The method for adjusting a transparency of a displayable object within a graphical interface according to claim 1, said method further comprising the step of:
selecting said particular z-order level within a graphical interface according to at least one from among a keystroke, an audible input, a scroll wheel rotation input, and a graphical selection.

5. The method for adjusting a transparency of a displayable object within a graphical interface according to claim 1, said method further comprising the step of:
adjusting a position of a transparency controller within said at least one displayable object according to said adjustment in said transparency.

6. A system for adjusting a transparency of a displayable object within a graphical interface, said system comprising:
a graphical user interface;
means for detecting a rotation of a scroll wheel position; and
means for adjusting a transparency of at least one displayable object located at a particular z-order level within said graphical user interface according to said rotation of said scroll wheel position.

7. The system for adjusting a transparency of a displayable object within a graphical interface according to claim 6, said means for adjusting a transparency further comprising:
means for adjusting a transparency of at least one window within a top level of said z-order.

8. The system for adjusting a transparency of a displayable object within a graphical interface according to claim 6, said system further comprising:
means for rotating an order of said at least one displayable object within said z-order.

9. The system for adjusting a transparency of a displayable object within a graphical interface according to claim 6, said system further comprising:
means for selecting said particular z-order level within a graphical interface according to at least one from among a keystroke, an audible input, a scroll wheel rotation input, and a graphical selection.

10. The system for adjusting a transparency of a displayable object within a graphical interface according to claim 6, said system further comprising:
means for adjusting a position of a transparency controller within said at least one displayable object according to said adjustment in said transparency.

11. A program for adjusting a transparency of a displayable object within a graphical interface, residing on a computer usable medium having computer readable program code means, said program comprising:
means for detecting a rotation of a scroll wheel position; and
means for controlling a transparency of at least one displayable object located at a particular z-order level within a graphical interface according to said rotation of said scroll wheel position.

12. The program for adjusting a transparency of a displayable object within a graphical interface according to claim 11, said program further comprising:
means for controlling adjustment of a transparency of at least one window within a top level of said z-order.

13. The program for adjusting a transparency of a displayable object within a graphical interface according to claim 11, said program further comprising:
means for controlling rotation of an order of said at least one displayable object within said z-order.

14. The program for adjusting a transparency of a displayable object within a graphical interface according to claim 11, said program further comprising:
means for enabling selection of said particular z-order level within a graphical interface according to at least one from among a keystroke, an audible input, a scroll wheel rotation input, and a graphical selection.

15. The program for adjusting a transparency of a displayable object within a graphical interface according to claim 11, said program further comprising:
means for controlling adjustment of a position of a transparency controller within said at least one displayable object according to said adjustment in said transparency.
